(19) United States
(12) Patent Application Publication
(10) Pub. No.: US 2026/0276190 A1
(43) Pub. Date: Sep. 17, 2026

(54) MAKEUP MIRROR LAMP CAPABLE OF AIR BLOWING AND FILL-LIGHT ILLUMINATION

(71) Applicant: Dongguan Mizhi Intelligent Technology Co., Ltd., Dongguan (CN)

(72) Inventors: Lin Zhang, Meishan (CN); Huabing Ou, Zhongjiang (CN); Xiaoping Gao, Meishan (CN)

(21) Appl. No.: 19/672,595

(22) Filed: May 9, 2026

(51) Int. Cl. F21V 33/00; A47G 1/02; A47G 1/16; F04D 25/08; F21S 4/28; F21S 6/00; F21V 3/04; F21V 3/06; F21V 7/00; F21V 21/30; F21V 23/04; F21W 131/302; F21Y 105/18; F21Y 115/10

(52) U.S. Cl. CPC F21V 33/004; A47G 1/02; F04D 25/08; F21S 4/28; F21S 6/003; F21V 3/049; F21V 3/0615; F21V 7/0058; F21V 23/04; F21V 33/0096; A47G 1/166; A47G 2001/1673; F21V 21/30; F21W 2131/302; F21Y 2105/18; F21Y 2115/10

(57) ABSTRACT

A makeup mirror lamp capable of air blowing and fill-light illumination includes a base, a lamp body, a ventilation mechanism, and an illumination mechanism. The base supports the lamp body and is provided with a switch and a power interface. An air duct and a fan are disposed in the lamp body, and rear air inlets communicate with an annular air outlet through the air duct. The illumination mechanism is disposed at a front portion of the lamp body and includes a reflector, a light strip arranged around the reflector, and an outer-ring sandblasted glass lens covering LED chips, where luminous centers of the LED chips face a reflective surface. The present disclosure reduces heat in a makeup environment through annular airflow, and achieves soft and uniform light filling by means of secondary reflection.

### TECHNICAL FIELD

The present disclosure relates to the technical field of cosmetic appliances, and in particular to a makeup mirror lamp capable of air blowing and fill-light illumination.

### BACKGROUND

Makeup mirrors are tools widely used in the fields of personal care and beauty makeup. With the users'increasing demand for refined makeup, makeup mirrors with the fill-light function have gradually become popular. However, in an environment with poor air circulation or high temperature, a user easily sweats due to facial overheating during makeup application, leading to makeup smudging or meltdown. Makeup mirrors in the prior art typically only have the functions of reflective imaging and basic illumination, without effective cooling and air regulation mechanisms. When a makeup mirror is used in a stuffy environment, the rise in the user's facial temperature directly affects makeup efficiency and longevity. Additionally, lighting systems in the prior art still have limitations in light distribution and uniformity, thereby making it difficult to provide a comfortable and stable fill-light environment. Therefore, makeup mirrors in the prior art have technical deficiencies of low functional integration, inability to achieve fill-light and heat dissipation functions synchronously, and difficulty to achieve makeup comfort and longevity in high-temperature environments.

### SUMMARY

An objective of the present disclosure is to provide a makeup mirror lamp capable of air blowing and fill-light illumination, so as to overcome the deficiencies in the prior art.

To achieve the above objective, the present disclosure adopts the following technical solution:

A makeup mirror lamp capable of air blowing and fill-light illumination, where the makeup mirror lamp capable of air blowing and fill-light illumination includes a base, a lamp body, a ventilation mechanism, and an illumination mechanism. In the makeup mirror lamp:

The base provides support for an integral structure, a bottom of the base is provided with a horizontally arranged supporting surface, and an accommodating space is formed in the base. The lamp body is fixedly connected above the base through a connecting bracket, and a fixed spatial positional relationship is maintained between the lamp body and the base. A pair of switch buttons is disposed on a surface of the base, and the switch buttons are connected to a control circuit board through internal wiring. A power interface is arranged in a back area of the base in an embedded manner, and the power interface is configured to connect an external power supply to provide power for the whole device.

A housing of the lamp body has a circular structure or a square structure, a hollow cavity is formed in the lamp body, and an inner wall of the cavity defines and forms an air duct for airflow circulation. A plurality of rear air inlets arranged in an array manner are arranged on a rear housing of the lamp body, and a continuously distributed annular air outlet is formed on a front edge area of the lamp body. The rear air inlets physically and spatially communicate with the annular air outlet through the air duct. A fan is accommodated in the air duct, and the fan includes a power motor and a fan blade set mechanically connected to an output shaft of the power motor. The power motor is electrically connected to the control circuit board through a wire. The control circuit board adjusts a rotating speed and start/stop state of the power motor according to an electric signal triggered by the switch buttons.

Further, the illumination mechanism is disposed at a front portion of the lamp body. A reflector is inwardly recessed in a central area of the front portion of the lamp body, and a reflective surface of the reflector faces an operation space in front of the lamp body. The annular air outlet is arranged around an outer peripheral edge of the reflector. An opening plane of the annular air outlet is perpendicular to a central axis of the reflector, and an air ejection direction of the annular air outlet faces a space in front of the lamp body. A light strip is arranged around a middle portion of the reflector, i.e., an annular path close to a central area of the reflector. A plurality of LED chips distributed at equal intervals are fixedly arranged on a side wall of a flexible substrate of the light strip. In particular, luminous central axes of all the LED chips are directed toward a reflective surface of the reflector. An outer-ring sandblasted glass lens is fixedly installed in front of the reflector, the outer-ring sandblasted glass lens is made of a high-light-transmitting mirror glass material, and an outer ring thereof is sandblasted to form a frosted texture with a diffuse reflection function. The outer-ring sandblasted glass lens completely covers front areas of the light strip and the LED chips to form an enclosed optical chamber.

An implementation of the ventilation mechanism is further refined, and an inner wall of the air duct is designed to be smooth and streamlined, to reduce frictional resistance of air in a flow process. Fan blades of the fan are calibrated by dynamic balance to reduce vibration and noise during operation. When the power motor drives the fan blade set to rotate, a negative pressure area is generated in the air duct, and external air enters the air duct through the rear air inlets. The airflow converges and flows forward under the guidance of the air duct, and is finally ejected under pressure through a constricted structure of the annular air outlet. The inclined guide surface design of the annular air outlet ensures that the ejected airflow forms a conical airflow field converging toward a center, and the airflow field accurately covers the user's facial and head areas in front of the mirror, thereby achieving an efficient convective heat exchange effect.

A working mechanism of the illumination mechanism is further refined, and original light emitted by the LED chips is first projected onto the reflective surface of the reflector. After first directional reflection by the reflector, the light is converged and projected to the outer-ring sandblasted glass lens. When the light passes through the glass lens with the frosted texture, multi-angle diffuse reflection occurs on a microscopically rough surface, such that finally output light has the characteristics of being highly uniform, soft, and shadow-free. In an illumination mode based on the secondary optical design, a natural light environment is effectively simulated, and visual stimulation of hard light on facial skin is eliminated.

Compared with the prior art, the present disclosure has the beneficial effects as follows:

By integrally designing the air duct with a specific path, the fan, and the annular air outlet (arranged around the outer peripheral edge of the reflector) in the inner cavity of the lamp body, the present disclosure provides a continuous and stable surrounding airflow to the user's face while filling light, and physically solves the technical problem of makeup smudging caused by body temperature rise in hot environments, significantly enhancing the comfort in the makeup process. Additionally, the present disclosure abandons a conventional layout of direct light irradiation, and achieves light uniformization through a backward light-emitting structure in which the LED chips face the reflector, and the glass lens with a frosted diffusion function, in combination with dual optical effects of reflection and diffuse reflection. The present disclosure effectively prevents visual fatigue of human eyes caused by strong light, and ensures the authenticity and softness of the fill-light effect. Due to these specific structural improvements, the present disclosure has significant practical value and technical advancement in the field of beauty care appliances.

### BRIEF DESCRIPTION OF THE DRAWINGS

FIG. 1 is a schematic structural view of a circular lamp of the present disclosure.

FIG. 2 is a sectional view of a circular lamp of the present disclosure.

FIG. 3 is a partial schematic view of a circular lamp of the present disclosure.

FIG. 4 is a schematic structural view of a back of a square lamp of the present disclosure.

Reference numerals in the accompanying drawings:

1-switch button; 3-annular air outlet; 4-fan; 5-rear air inlet; 8-outer-ring sandblasted glass lens; 9-reflector; 10-air duct; 11-light strip; 12-LED chip; and 14-power interface

### DETAILED DESCRIPTIONS OF THE EMBODIMENTS

The present disclosure is described in detail below with reference to the embodiments shown in the accompanying drawings:

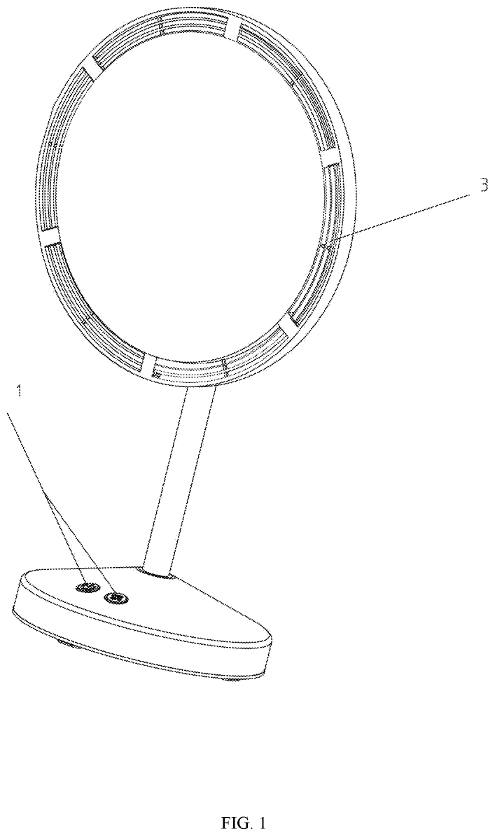

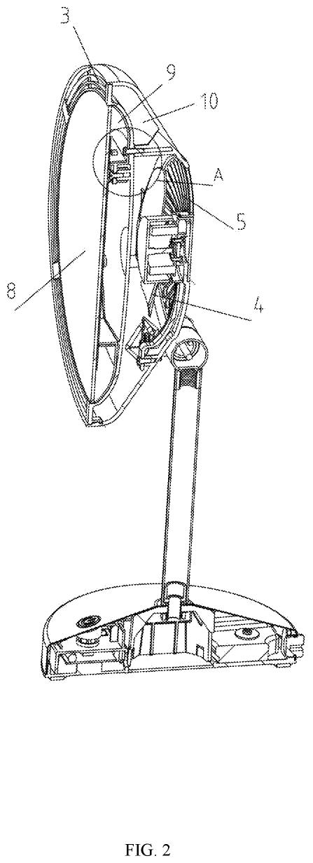

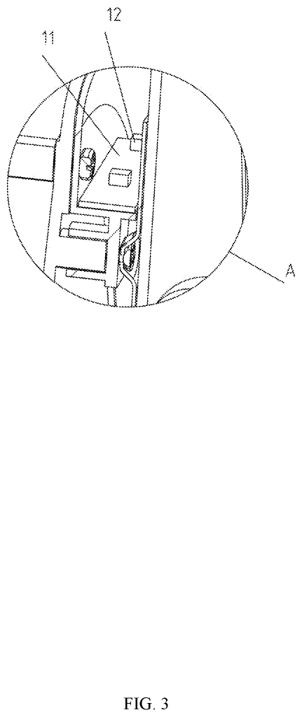

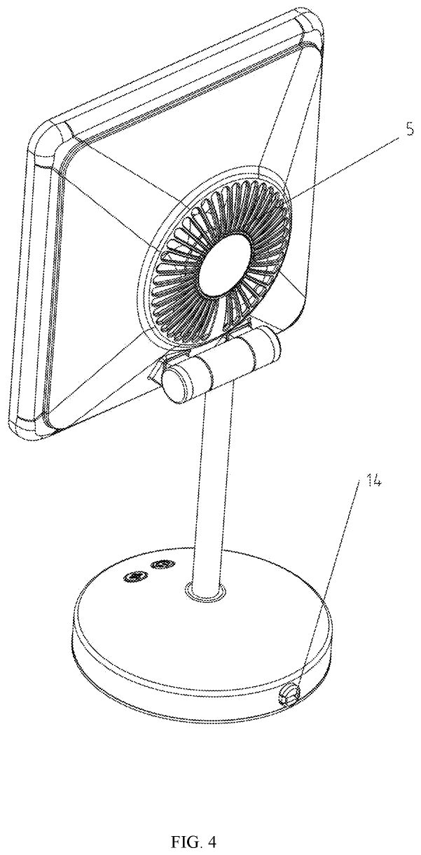

As shown in FIGS. 1 to 4, a makeup mirror lamp capable of air blowing and fill-light illumination is provided in the present embodiment, and an integral structure thereof is formed by a base, a lamp body, a ventilation mechanism, and an illumination mechanism that cooperate with each other. A horizontally distributed supporting plane is disposed at a bottom of the base as a supporting core of the makeup mirror lamp, and configured to be placed on a dressing table or any other horizontal plane. An accommodating space is formed in the base and configured to install a control circuit board and related electrical wiring. The base is made of iron and a counterweight to achieve sufficient structural strength and stability. A pair of switch buttons 1 is disposed on a surface of the base, and the switch buttons 1 are connected to the internal control circuit board through wires, where one of the switch buttons 1 is configured to adjust illumination brightness and an on/off state, and the other switch button 1 is configured to adjust a rotating speed and an on/off state of a fan 4. A power interface 14 is arranged in a back area of the base in an embedded manner, and the power interface 14 is an AC lead interface or a direct current power socket and provides continuous power supply for the makeup mirror lamp by connecting an external power cord or an adapter.

The lamp body is stably supported above the base through a connecting bracket. A housing of the lamp body has a circular structure or a square structure, and the geometric design not only meets aesthetic requirements, but more importantly, provides a standardized installation cavity for internal components. A hollow cavity is formed in the lamp body, and an inner wall of the cavity is smoothly treated to define and form an air duct 10 for airflow circulation. A plurality of rear air inlets 5 distributed in an array manner are arranged on a rear housing of the lamp body, and the design of the rear air inlets 5 increases an air intake area and reduces a resistance during air suction. A continuously distributed annular air outlet 3 is formed on a front edge area of the lamp body, a width of the annular air outlet 3 is set to be 2 mm to 5 mm, and the rear air inlets 5 physically and spatially communicate with the annular air outlet 3 through the air duct 10 to construct a complete airflow circulation path.

A specific implementation of the ventilation mechanism is as follows. A fan 4 is accommodated in the air duct 10, and the fan 4 includes a power motor and a fan blade set mechanically connected to an output shaft of the power motor. The power motor is a brushless direct current motor with the characteristics of high rotating speed, low noise, and long service life. The power motor is electrically connected to the control circuit board through a wire. When the control circuit board receives a pulse signal from the switch button 1, a corresponding pulse width modulation signal is output to control the rotating speed of the power motor. An inner wall of the air duct 10 is designed with a streamlined curved surface, and this design follows the principle of fluid mechanics and reduces a kinetic energy loss of airflow. When the fan 4 rotates, negative pressure is generated in the air duct 10, and external air is sucked in through the rear air inlets 5. The airflow flows to a front end of the lamp body under a guiding action of the air duct 10, and finally after kinetic energy conversion through a constricted structure of the annular air outlet 3, and the airflow is emitted to a user in a pressurized ejection form. An included angle of 15 degrees to 30 degrees is formed between a flow guide surface of the annular air outlet 3 and a central axis of the lamp body, such that the ejected airflow forms a conical airflow field converging toward a center, thereby accurately covering the user's facial and head areas in front of the mirror, achieving an effect of convective heat exchange, and dissipating heat from a skin surface.

The illumination mechanism is disposed at a front portion of the lamp body, and is configured to mainly solve the problems of facial shadows and glare caused by direct light irradiation in the prior art. A reflector 9 is inwardly recessed in a central area of the front portion of the lamp body, and a reflective surface of the reflector 9 exhibits high reflectivity through angle and texture optimization. The annular air outlet 3 is arranged around an outer peripheral edge of the reflector 9, and this layout ensures that the airflow uniformly wraps the user from a periphery of an illumination area. A light strip 11 is arranged around a middle portion of the reflector 9, i.e., an annular path close to the central area of the reflector. A plurality of LED chips 12 distributed at equal intervals are fixedly arranged on a side wall of a flexible substrate of the light strip 11. The LED chips 12 are light-emitting diodes with a high color rendering index to restore the real skin color. In particular, luminous central axes of all the LED chips 12 are directed toward a reflective surface of the reflector 9, and backward light-emitting design prevents the light from directly irradiating the user's eyes. An outer-ring sandblasted glass lens 8 is fixedly installed in front of the reflector 9, the outer-ring sandblasted glass lens 8 is made of a glass material with high light transmittance, and an outer surface of the outer-ring sandblasted glass lens is sandblasted to form a frosted texture. The outer-ring sandblasted glass lens 8 completely covers front areas of the light strip 11 and the LED chips 12 to form an enclosed optical chamber. Original light emitted by the LED chips 12 is first projected onto the reflector 9, and then projected to the outer-ring sandblasted glass lens 8 after first-order reflective convergence. The light undergoes multi-angle diffuse reflection when passing through a frosted surface of the outer-ring sandblasted glass lens 8, such that a uniform, soft, and shadow-free fill-light environment is generated for the user's face.

Through the above specific structural improvements of the outer-ring sandblasted glass lens 8, the present disclosure organically combines seemingly contradictory functions of air blowing and illumination in a same lamp body structure. The layout of the air duct cleverly utilizes a peripheral space of the lamp body, while the illumination mechanism occupies central and inner space, and the air duct and the illumination mechanism do not interfere with each other but complement each other. Through the annular air outlet design, all-round cooling effect on the user's face is achieved, and pain points of makeup in summer are addressed. Through the reflective fill-light design, illumination quality is improved.

The technical features of the above embodiments can be combined arbitrarily. For the sake of brevity, all possible combinations of the technical features in the above embodiments are not described. However, as long as the combinations of these technical features are not contradicted, they should be regarded to fall within the scope recorded in this specification. For those of ordinary skill in the art, they may also make several modifications and improvements without departing from the concept of the present disclosure, and these modifications and improvements shall fall within the protection scope of the present disclosure. Therefore, the scope of protection of the present disclosure shall be governed by the appended claims.

What is claimed is:

1. A makeup mirror lamp capable of air blowing and fill-light illumination, comprising:
a base, wherein an accommodating space is formed in the base, a switch button is disposed on a surface of the base, and a power interface is disposed on a back of the base;
a lamp body, wherein the lamp body is fixedly connected above the base through a connecting bracket, a hollow cavity and an air duct are formed in the lamp body, a plurality of rear air inlets are arranged on a rear housing of the lamp body, an annular air outlet is disposed on a front edge area of the lamp body, and the rear air inlets communicate with the annular air outlet through the air duct;
a ventilation mechanism, comprising a fan accommodated in the air duct, and the fan is electrically connected to a control circuit board through a wire; and
an illumination mechanism, disposed at a front portion of the lamp body, wherein the illumination mechanism comprises a reflector disposed in a central area of the front portion of the lamp body, a light strip arranged around a side position of the reflector, and an outer-ring sandblasted glass lens fixedly installed in front of the reflector, a plurality of LED chips are arranged on the light strip, and the outer-ring sandblasted glass lens completely covers front areas of the light strip and the LED chips.

2. The makeup mirror lamp capable of air blowing and fill-light illumination according to claim 1, wherein an inner wall of the air duct has a streamlined curved surface structure, and a cross-sectional area of the air duct is gradually reduced in a direction from the rear air inlets to the annular air outlet.

3. The makeup mirror lamp capable of air blowing and fill-light illumination according to claim 1, wherein an included angle of 15 degrees to 30 degrees is formed between a flow guide surface of the annular air outlet and a central axis of the lamp body, and an opening plane of the annular air outlet is perpendicular to a central axis of the reflector.

4. The makeup mirror lamp capable of air blowing and fill-light illumination according to claim 1, wherein luminous central axes of all the LED chips are directed toward a reflective surface of the reflector.

5. The makeup mirror lamp capable of air blowing and fill-light illumination according to claim 1, wherein an outer ring surface of the glass lens is provided with a frosted texture formed by sandblasting, and the outer-ring sandblasted glass lens is adhesively bonded to the reflector.
